(19) United States
(12) Patent Application Publication
(10) Pub. No.: US 2010/0153725 A1
(43) Pub. Date: Jun. 17, 2010

(54) TRAFFIC ENCRYPTION KEY UPDATING METHOD USING SYSTEM SYNCHRONIZATION AND APPARATUS USING THE SAME

(76) Inventors: Han Seung KOO, Daejeon (KR); Yun Jeong SONG, Daejeon (KR); Soo In LEE, Daejeon (KR)

Correspondence Address: LADAS & PARRY LLP, 224 SOUTH MICHIGAN AVENUE, SUITE 1600, CHICAGO, IL, 60604, US

(21) Appl. No.: 12/541,265

(22) Filed: Aug. 14, 2009

(30) Foreign Application Priority Data
Dec. 16, 2008 (KR) 10-2008-0128050

(51) Int. Cl. H04L 9/08; H04L 9/00; H04L 9/32; G06F 15/16

(52) U.S. Cl. 713/170; 380/47; 380/278; 709/248; 380/277

(57) ABSTRACT

Provided are a TEK update method using system synchronization, and an apparatus using the same. The method and apparatus according to the present invention periodically update a TEK used for traffic encryption in a DOCSIS system by using system synchronization. As described, the TEK can be updated by using system synchronization without performing a TEK update negotiation process.

### CROSS-REFERENCE TO RELATED APPLICATION

This application claims priority to and the benefit of Korean Patent Application No. 10-2008-0128050 filed in the Korean Intellectual Property Office on Dec. 16, 2008, the entire contents of which are incorporated herein by reference.

### BACKGROUND OF THE INVENTION

(a) Field of the Invention

The present invention relates to a traffic encryption key (TEK) updating device using system synchronization, and a method thereof.

(b) Description of the Related Art

A data over cable service interface specification (DOCSIS) is an international standard for cable modems involved in data exchange between a cable broadcasting operator and subscribers. Based on the DOCSIS, a system where bidirectional communication is performed between a cable model (CM) and a cable model termination system (CMTS) is referred to as a DOCSIS system.

Since watching qualification management of the charged broadcasting provided through the DOCSIS system is related to profits of a broadcasting provider, the charged broadcasting should be provided through a high-level security system. Therefore, like a general moving picture experts group (MPEG) system-based CAS, a charged broadcasting data encryption key should be updated with a period as short as 1 to 20 seconds in order to increase the security level of charged broadcasting data.

The DOCSIS system uses a traffic encryption key (hereinafter referred to as TEK) for ensuring confidentiality of IP traffic transmitted to the CM. The TEK is operated based on a symmetric key, and an update period is generally determined within a range 1 to 604,800 seconds.

Typically, in an MPEG system-based conditional access system (CAS), a control word performs a function of an encryption key for charged broadcasting traffic. In addition, in a DOCSIS system-based Internet protocol television IPTV CAS, a TEK performs a function of an encryption key for the charged broadcasting traffic.

However, the CMTS and the CM should perform a media access control (MAC) management process, which is referred to as TEK rekeying negotiation, at every TEK update period. Therefore, as the TEK update period is decreased, the TEK rekeying negotiation process is iteratively performed, thereby increasing system overhead.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide an apparatus that periodically updates a traffic encryption key (TEK) used for traffic encryption in a DOCSIS system by using system synchronization, and a method thereof.

An exemplary TEK update method of a cable modem termination system performing system synchronization with a cable modem according to an embodiment of the present invention, includes generating a first TEK to be provided to the cable modem based on authentication information received from the cable modem, calculating an update time of the first TEK, and generating a second TEK by updating the first TEK based on the calculated update time.

An exemplary TEK update method of a cable modem performing system synchronization with a cable modem termination system according to another embodiment of the present invention includes receiving a first TEK generated in the cable modem termination system, calculating an update time of the first TEK, and generating a second TEK by updating the first TEK based on the calculated update time.

An exemplary TEK updating system according to another embodiment of the present invention updates a TEK for encoding and decoding data transmitted/received between a cable modem termination system and a cable modem. The TEK updating system includes: a TEK update time calculator calculating a TEK update time by using a time offset calculated through system synchronization between the cable modem termination system and the cable modem, an expiration time of a previously generated TEK, and time information that a key response message including the TEK is transmitted to the cable modem from the cable modem termination system; a TEK updating unit updating the TEK by applying the TEK update time calculated by the TEK update time calculator and the previously generated TEK to a hash function; and transmitting a key request message when receiving the authorization response message, and receiving a key response message including the first TEK generated for the key request message.

### BRIEF DESCRIPTION OF THE DRAWINGS

FIG. 1 is a flowchart of a general TEK updating method in a DOCSIS system.

FIG. 2 is a flowchart of a TEK updating method according to an exemplary embodiment of the present invention.

FIG. 3A is a configuration diagram of a TEK updating unit in a CMTS, and FIG. 3B is a configuration diagram of a TEK updating unit in a CM.

FIG. 4 shows an initial ranging process according to the exemplary embodiment of the present invention.

FIG. 5 shows an example of TEK update time calculation according to the exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, unless explicitly described to the contrary, the word “comprise” and variations such as “comprises” or “comprising” will be understood to imply the inclusion of stated elements but not the exclusion of any other elements.

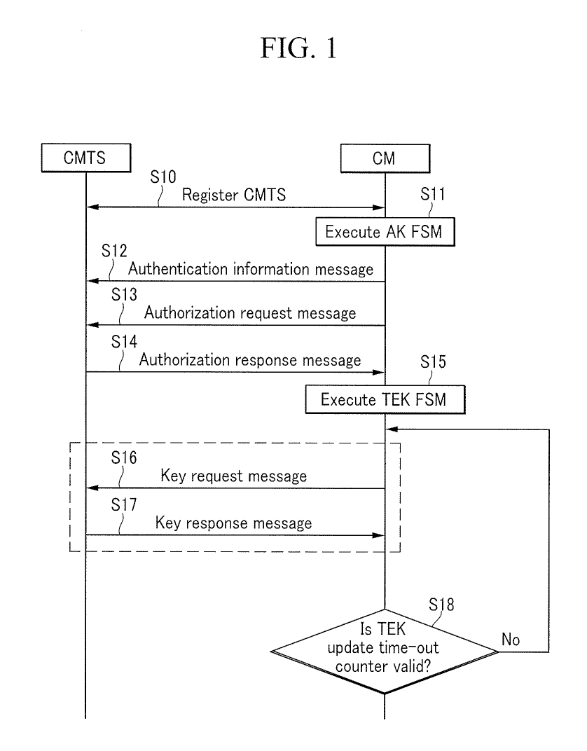

Before starting to describe a traffic encryption key (TEK) updating method according an exemplary embodiment of the present invention, a general method for updating a TEK used in traffic encryption in a DOCSIS system will be described with reference to FIG. 1.

FIG. 1 shows a general method for updating a TEK in a DOCSIS system.

As shown in FIG. 1, a CMTS registration process is performed for forming a bidirectional communication channel between a CM and a CMTS (S10). When the communication channel is formed between the CM and the CMTS, the CM transmits a certificate (e.g., a manufacturer CA or CableLabs Mfg CA, etc.) of the CM, issued by a root certification authority (RCA) of the DOCSIS system by using an authentication information message to the CMTS (S12).

A process in which the CM transmits the certificate to the CMTS is an option so that the CMTS may disregard authentication information message transmitted from the CM under specific circumstances. However, if the CMTS does not have another method to acquire a certificate of the corresponding CM, the CMTS should acquire the corresponding certificate through an authentication information message.

The CM should acquire an authorization key (AK) first to acquire a TEK for media access control (MAC) traffic decoding. To acquire the AK, the CM executes an AK finite state machine (FSM) installed therein (S11). Then, the AK FSM generates an authorization request message for an AK request and transmits the message to the CMTS (S13).

The CMTS received the authorization request message determines whether the corresponding CM is authorized to receive an AK based on CM authentication information. If the CMTS determines that the CM is not authorized to receive the AK, the CMTS transmits an authorization reject message to the CM. However, if the CMTS determines that the CM is authorized to receive the AK, the CMTS transmits an authorization response message to the CM. The authentication response message transmitted to the CM includes the AK (S14).

When receiving the AK, the CM executes a TEK FSM (S15). Here, the TEK FSM is generated as many times as the number of security association IDs (SAIDs) included in a security association-descriptor in the authorization message transmitted from the CMTS, and the number of SAIDs can be checked through the CMTS registration process of step S10. The generated TEK FSMs respectively request a TEK corresponding to each SAID from the CMTS by using a key request message (S16).

The CMTS having received the key request message from the CM verifies whether the received message is transmitted from a valid CM through a hash message authentication code digest included in the key request message. If the verification fails, the CMTS transmits a key reject message to the corresponding CM. However, if the verification is successful, the CMTS transmits a key replay message to the corresponding CM (S17).

In this case, traffic encryption key parameter values are encrypted in the 3DES encrypt decrypt encrypt (EDE) mode. After that, the TEK FSM transmits a key request message to the CMTS again before the corresponding traffic encryption key has expired in order to request a newly updated TEK. This process is referred to a TEK update negotiation process.

The CM having received the TEK from the CMTS determines whether a TEK update time-out counter is still valid (S18), and performed the above process from step S16 to be issued with a TEK if the time-out counter has expired. However, if the time-out counter has not expired, the CM encrypts data by using the TEK received from the CMTS through step S17.

As described, the general TEK updating method updates a TEK with a predetermined time gap so that system overhead may occur. Therefore, a periodic TEK updating method that can minimize the overhead of the DOCSIS system while updating the TEK with a short period is required.

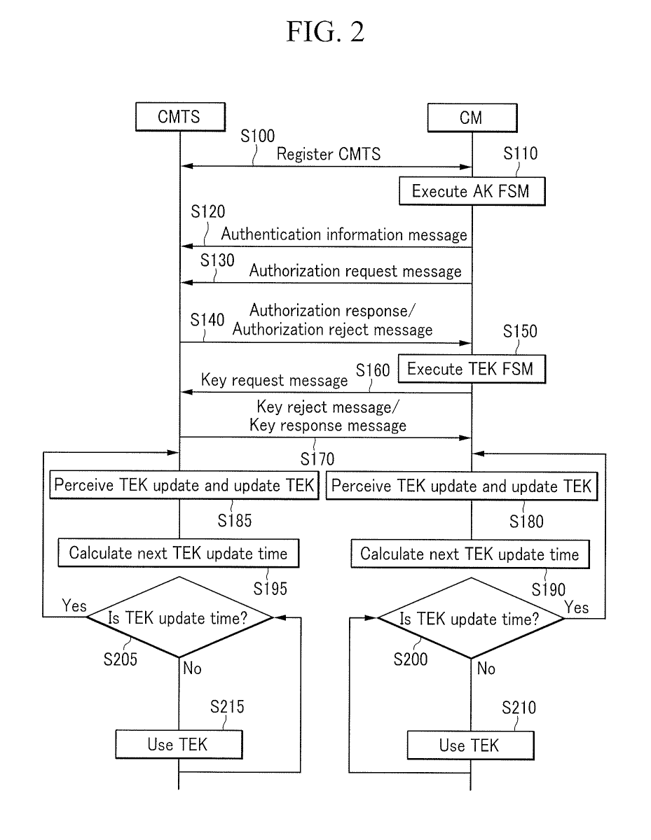

Hereinafter, referring to FIG. 2 to FIG. 4, a TEK updating method according to an exemplary embodiment of the present invention will be described.

FIG. 2 is a flowchart of a traffic encryption key updating method according to the exemplary embodiment of the present invention.

As shown in FIG. 2, when a TEK is updated according to the exemplary embodiment of the present invention, repetition of the TEK update negotiation process performed between the CMTS and the CM is omitted.

In FIG. 2, a CMTS registration process (S100) for forming a bidirectional communication channel between the CM and the CMTS to a process (S140) of transmitting an authorization response message to the CM are the same as the general processes shown in FIG. 1.

That is, in an initial power-on state of the CM, a communication channel is not formed between the CM and the CMTS, and an AK and a TEK for communication of the CM are not issued. Therefore, the CM performs a process for registration to the CMTS (S100) to form a communication channel between the CM and the CMTS, and executes an AK FSM (S110).

Then, the CM transmits a certificate of the CM to the CMTS by using an authentication information message (S120). In this case, the certificate transmission process of the CM to the CMTS may be selectively performed. That is, since the CMTS can acquire the certificate of the CM without receiving the authentication information message, the certificate transmission process may not be necessary. However, if the CMTS cannot have a method to acquire the certificate of the CM, the CMTS should acquire the certificate of the CM through the authentication information message.

Next, the CM performs a process for acquiring a traffic encryption key. Here, the traffic encryption key refers to a key for DOCSIS MAC traffic decoding. In order to acquire the traffic encryption key, an AK should be acquired first. Therefore, the CM requests an AK from the CMTS through an authentication request message (S130), and transmits an authorization response message that includes an AK to a CM that is authorized to receive the AK (S140).

If the CMTS determines that the CM is not authorized to receive the AK, the CMTS transmits an authorization reject message to the CM (S140). In FIG. 2, the authorization response message and the authorization reject message are transmitted at once through step S140. However, this does not imply that the two messages are simultaneously transmitted. That is, one of the two messages is selectively transmitted according to the determination result of the CMTS.

The CM received the AK performs a traffic encryption key acquisition process for substantial traffic encryption. For this, the CM executes the TEK FSM first (S150), and requests issuing of a TEK from the CMTS through a key request message (S160).

The CMTS having received the key request message determines whether a valid CM has requested the key, and if the CM is a valid CM, the CMTS issues a TEK for the CM and provides the TEK by including the TEK in the key response message (S170). However, if the CM is an invalid CM, the CMTS transmits an authorization reject message (S170). In this case, TEK parameter values can be encrypted by various methods and then transmitted to the CM, and the encryption of the TEK parameter values are performed in the 3DES EDE mode according to the exemplary embodiment of the present invention.

The CM issued with the TEK calculates an update time in advance without performing a traffic encryption key updating negotiation process that has been performed with the CMTS, and updates the issued TEK at the calculated update time. That is, the CMTS and the CM respectively calculate an accurate traffic encryption key update time through system time synchronization therebetween, and respectively update existing traffic encryption keys by using a hash function when the calculated time is reached.

When the calculated update time comes, the CMTS and the CM updates the TEK after perceiving update of the TEK (S180 and S185), and respectively calculate a TEK reissuing time (S190 and S195). The TEK reissuing time is calculated through the system time synchronization between the CMTS and the CM. During use of the update TEK for data encryption, the CMTS and the CM determine whether a current time is a TEK reissuing time, that is, a time to update the TEK (S200 and S205), and performs a process after step S180 for updating the old TEK to a new TEK by using a hash function if the current time is the TEK update time.

However, if the current time is not the TEK update time, the CMTS and the CM continuously encrypt data by using the TEK updated in step S180 (S210 and S215). In addition, the CMTS and the CM respectively perform step S200 or S205.

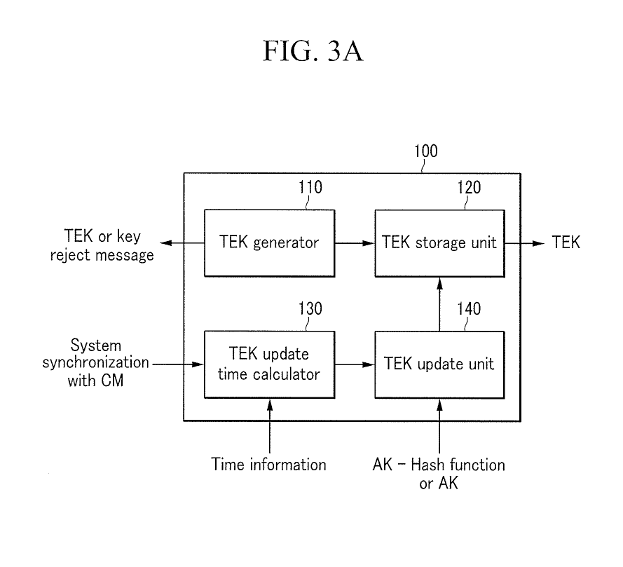

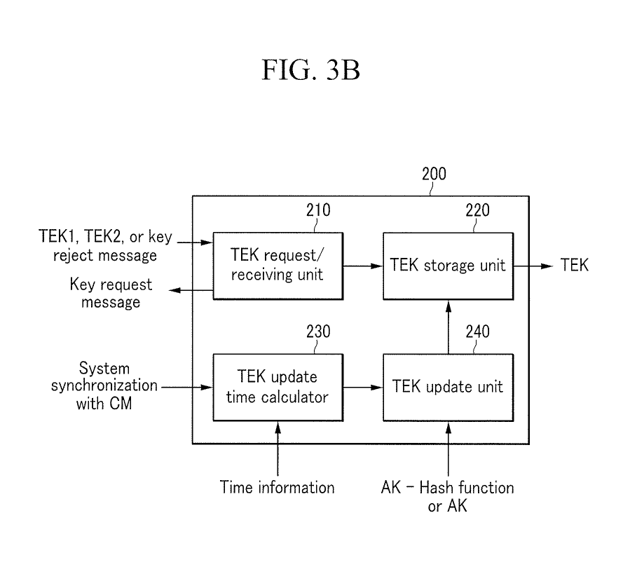

In order to describe the above-described system that calculates a TEK reissuing time through the system time synchronization and the method thereof in further detail, a structure of a TEK updating unit, an initial ranging process, and a TEK updating time calculation method will be described with reference to FIG. 3A to FIG. 5.

First, FIG. 3A is a configuration diagram of a TEK updating unit in the CMTS, and FIG. 3B is a configuration diagram of a TEK updating unit in the CM.

A TEK updating unit 100 in the CMTS and a TEK updating unit 200 in the CM respectively include TEK storage units 120 and 220, TEK update time calculators 130 and 230, and TEK updating units 140 and 240. In addition, the TEK updating unit 100 in the CMTS further includes a TEK generator 110, and the TEK updating unit 200 in the CM further includes a TEK request/receiving unit 210.

The TEK storage units 120 and 220 respectively store a TEK generated in the CMTS or TEKs updated by the CMTS and the CM to use them for traffic encryption.

The TEK update time calculators 130 and 230 calculate TEK update time for TEK update after time is synchronized through a system synchronization process between the CMTS and the CM. In this case, the TEK update time calculators 130 and 230 externally receive time information in FIG. 3A and FIG. 3B, but it is not limited thereto. A method for calculating TEK update time will be described later.

When the update time calculated by the TEK update time calculators 130 and 230 is reached, the TEK updating units 140 and 240 update TEKs that have been issued and used. In this case, the TEKs are updated by using the hash function together with the TEKs or by receiving an AK.

Next, the TEK generator 110 of the CMTS generates an initial TEK based on a key request message transmitted from the TEK request/receiving unit 210 of the CM at initial operation of the CM. In this case, when generating the initial TEK, two encrypted TEKs, that is, TEK1 and TEK2, are generated and transmitted to the CM, and stored in the TEK storage unit 120. In the exemplary embodiment of the present invention, TEK1 and TEK2 are simultaneously generated when the initial TEK is generated, but it is not limited thereto.

In addition, the TEK generator 110 determines whether the corresponding CM is a valid CM with reference to the key request message received from the CM, and outputs the two TEKs if the CM is valid. If the corresponding CM is invalid, the TEK generator 110 generates an authorization reject message to inform invalidity of the corresponding CM and outputs the message. In this case, the TEK generator 110 determines whether the corresponding CM is valid or not based on HMAC-Digest included in the key request message, and as this is known to a person skilled in the art, no detailed description will be provided in the exemplary embodiment of the present invention.

The TEK request/receiving unit 210 of the CM not only generates and transmits the TEK request message to request a TEK from the CMTS, but also receives the two encrypted TEKs generated at the initial stage from the CMTS. If the CMTS determines that the CM that has transmitted the key request message is an invalid CM, the TEK request/receiving unit 210 may receive an authorization reject message from the TEK generator 110 of the CMTS.

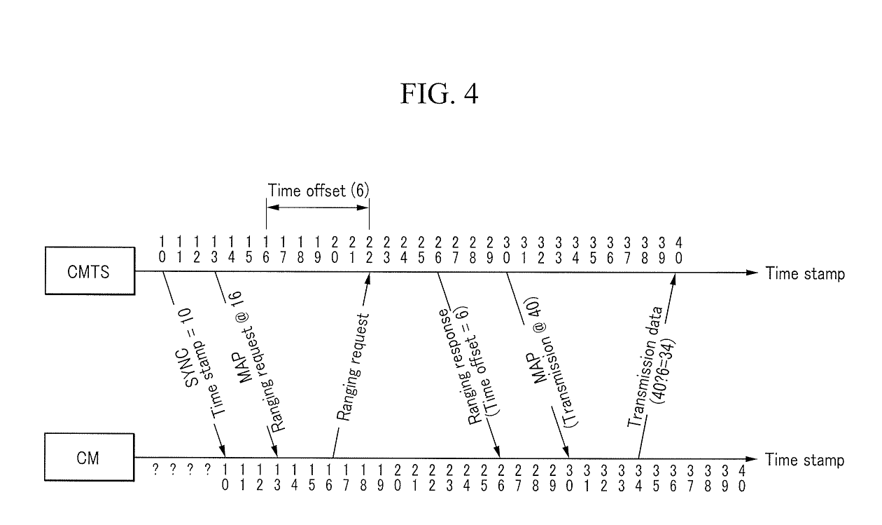

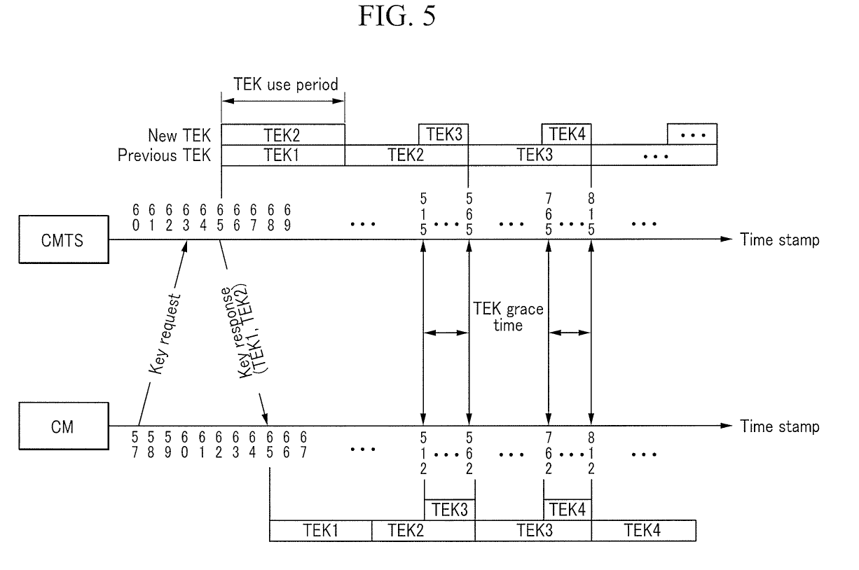

A system synchronization method and a TEK updating time calculation method for TEK reissuing using the updating unit described above will be described with reference FIG. 4 and FIG. 5.

FIG. 4 is an example of an initial ranging process according to an exemplary embodiment of the present invention.

In the DOCSIS system, time division multiple access (TMDA) is used for uplink communication so that the CM and the CMTS cannot bi-directionally communicate if system time synchronization between the CMTS and the CM has failed. Therefore, the DOCSIS system should continuously maintain accurate system time synchronization during system operation so as to support stable bidirectional communication between the CMTS and the CM.

Therefore, the CMTS synchronizes system clock frequency by broadcasting a sync message including a 32-bit time stamp to the CM. However, a signal transmission delay error, that is, a system clock phase error generated due to a different physical distance between the CM and the CMTS, cannot be compensated by the sync message. Accordingly, the DOCSIS system requires compensation of not only a clock frequency error but also a system clock phase error by using the sync message.

The DOCSIS system performs a ranging process for calculating a time offset value which is a signal transmission delay value between a CMTS clock and a CM clock as shown in FIG. 4 so as to compensate the system clock phase error. FIG. 4 shows an example of an initial ranging process among several ranging processes performed by the DOCSIS system.

In FIG. 4, the two time axes respectively denote time stamp values in time offset units in the CMTS and the CM. In the exemplary embodiment of the present invention, the time offset unit implies, as an example, 97.65625 nanoseconds, and a time stamp counter has, as an example, a period of 419.43 seconds. In FIG. 3, the time offset value of the CM is 6. That is, when a time stamp included in a sync message that the CMTS has broadcasted for synchronization is set to 10, the CM having received the sync message sets a current CM time by using the time stamp included in the message.

In addition, when the CMTS transmits a ranging request message to the CM with a MAP, the CM transmits a CMTS ranging request message based on predetermined information included in the ranging request message. Here, if it is assumed that a value that the CMTS set in the ranging request message is 16, the CM transmits the ranging request message when the CM time reaches 16.

When receiving the ranging request message transmitted from the CM, the CMTS checks a message receiving time and checks a time set in the message to set a time that is different therebetween as a time offset. In FIG. 3, the ranging request message transmitted from the CM at 16 seconds is received at the CMTS at 22 seconds, and therefore the time offset is 6. The CMTS includes the time offset in a ranging response message, and transmits the message to the CM to make the terminal transmit a message earlier by the time offset.

In the present invention, the system synchronization method is exemplarily described through the initial ranging process, but it is not limited thereto. Next, referring to FIG. 5, a TEK update time calculation method according to the exemplary embodiment of the present invention will be described.

FIG. 5 shows an example of a TEK update time calculation according to the exemplary embodiment of the present invention.

As shown in FIG. 5, it is assumed that the CM requests a TEK from the CMTS by using a request message when the time stamp value reaches 57 during a CM registration process. Then, the CMTS generates two encrypted TEKs, TEK1 and TEK2, and transmits the TEKs TEK1 and TEK2 to the corresponding CM through a key response message when the time stamp value reaches, for example, 65. In this case, the two TEKs are generated for continuity of key use. This has already been defined in the DOCSIS, and therefore further description will not be provided in the exemplary embodiment of the present invention.

When the CMTS transmits the key response message including the TEKs, a time stamp value D_{active} is also included in the message. Here, D_{active} denotes a TEK active time period. The CM receives the key response message when the time stamp is 65, decodes the encrypted TEKs TEK1 and TEK 2 included in the message, and sequentially uses the decoded TEKs for DOCSIS traffic decoding. In this case, a TEK to be used for the DOCSIS traffic decoding among the TEK1 and TEK2 can be identified by using a key sequence (KEY_SEQ) field value and a toggle (TOGGLE) field value included in a DOCSIS MAC packet header. Here, an arrival time of the key response message to the CM is defined as T_{KeyReply}.

The CM should request a new KET from the CMTS before expiration of the TEK2 while using the TEK1 and the TEK2 in order to provide a seamless traffic encryption service. That is, the CM decoding encrypted data by using the TEK1 decodes the encrypted data by using the TEK2 when the expiration time of the TEK1 comes. In addition, the CM should request a new TEK before the TEK2 has expired while decoding the encrypted data by using the TEK2. The request time is referred as T_{InitUpdate}, that is, a TEK updating time, and can be calculated by Equation 1. Equation 1 is used for initial update of the TEK.

$${T}_{InitUpdate} = {T}_{KeyReply} [ + ] 2 {D}_{active} [ - ] \frac{{O}_{i}}{2} [ - ] {Δ}_{grace} \qquad ( Equation 1 )$$

Here, “A[+]B” and “A[−]B” respectively imply that the time stamp value is shifted toward or away from A by B. In addition, Δ_{grace} denotes a time difference from a TEK expiration time to a time that the CM substantially requests a new TEK. Oᵢ denotes a time offset of the i-th CM.

In Equation 1, if T_{KeyReply} is set to 65 and D_{active} is set to 250 as shown in FIG. 5, Qᵢ is set to 6 as shown in FIG. 4 and Δ_{grace} is set to 50 which is a value that corresponds to a time difference between TEK expiration time 565 to a TEK request time 515, so T_{InitUpdate} is calculated to be 512. Therefore, the CM performs a new TEK issuing process to the CMTS when the time stamp value is 512.

When the time stamp value of the CM is T_{InitUpdate}, the CM obtains a TEK3 by inputting the TEK2 as an input value to the hash function. After that, the CM decodes DOCSIS traffic of which a key sequence number in a DOCSIS packet header is incremented by 1 by using the TEK3.

After calculating the initial TEK update time of the TEK3, update times of other TEKs are calculated by using Equation 2.

T_{NextUpdate}=T_{PrevUpdate}[+]D_{active} (Equation 2)

Herein, T_{PrevUpdate} denotes an update time of a TEK that is currently used for DOCSIS traffic decoding. That is, 512, which is a value that is calculated as given in Equation 1, becomes T_{PrevUpdate} according to the exemplary embodiment of the present invention. If this is applied to Equation 2, D_{TEK}=250 and accordingly T_{NxtUpdate} becomes 762.

Therefore, the CM generates TEK4 by inputting TEK3 as an input value of the hash function when the time stamp value reaches 762. In addition, the newly generated TEK4 is used for decoding traffic of which a key sequence number in a DOCSIS traffic packet header is incremented by 1 after the time stamp value is 762.

In the exemplary embodiment of the present invention, the hash function is used for TEK update. However, when a new TEK is generated by using the hash function, newly updated TEKs may be sequentially exposed when the old TEK is exposed if only an old TEK is used as an input value. In order to prevent this weak point, an AK is also used as an input value in addition to the old TEK to update a TEK as shown in Equation 3 according to the exemplary embodiment of the present invention.

TEK_{new}=HASH(TEK_{old}, AKᵢ₎ (Equation 3)

Therefore, it is impossible to determine if all the TEKs are updated even though information for a single TEK is exposed. As necessary, instead of the AK, a user group key (UGK) and the old TEK may be used as an input value to the hash function. When the CMTS provides unicast services to the CM, the AK is used, and when the CMTS provides group multicast services to the CM, the UGK is used.

FIG. 5 shows an example of TEK update time calculation in the viewpoint of the CM, but the CMTS calculates a TEK update time by using the same method.

According to the embodiments of the present invention, a TEK is updated by using system synchronization rather than performing a TEK negotiation process in a DOCSIS system so that communication overhead can be reduced.

The above-described embodiments can be realized through a program for realizing functions corresponding to the configuration of the embodiments or a recording medium for recording the program in addition to through the above-described device and/or method, which is easily realized by a person skilled in the art.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A traffic encryption key (TEK) update method of a cable modem termination system performing system synchronization with a cable modem, comprising:
generating a first TEK to be provided to the cable modem based on authentication information received from the cable modem;
calculating an update time of the first TEK; and
generating a second TEK by updating the first TEK based on the calculated update time.

2. The TEK update method of claim 1, wherein the generating of the first TEK comprises:
performing a registration process with the cable modem;
receiving an authentication information message including a certificate and an authorization request message for issuing an authorization key of the cable modem from the cable modem;
transmitting an authorization response message to the cable modem in response to the authorization request message;
receiving a key request message transmitted from the cable modem that has received the authorization response message, and generating the first TEK for the key request message; and
transmitting a key response message including the first TEK therein to the cable modem.

3. The TEK update method of claim 2, wherein the calculating of the update time comprises:
checking a time offset calculated during a ranging process performed for system synchronization with the cable modem through the registration process; and
calculating an update time of the first TEK by using the checked time offset, a first TEK expiration time, and time information that the key response message is transmitted to the cable modem.

4. A traffic encryption key (TEK) update method of a cable modem termination system performing system synchronization with a cable modem, comprising:
receiving a first TEK generated in the cable modem termination system;
calculating an update time of the first TEK; and
generating a second TEK by updating the first TEK based on the calculated update time.

5. The TEK update method of claim 4, wherein the receiving of the first TEK comprises:
performing a registration process with the cable modem termination system;
transmitting an authentication message including a certificate and an authorization request message for issuing of an authorization key to the cable modem termination system;
receiving an authorization response message from the cable modem termination system; and
transmitting a key request message when receiving the authorization response message, and receiving a key response message including the first TEK generated for the key request message.

6. The TEK update method of claim 5, wherein the calculating of the update time comprises:
checking a time offset calculated during a ranging process performed for system synchronization with the cable modem termination system through the registration process; and
calculating an update time of the first TEK by using the checked time offset, a first TEK expiration time, and time information that the key response message is received from the cable modem termination system.

7. A traffic encryption key (TEK) updating system that updates a TEK for encoding and decoding data transmitted/received between a cable modem termination system and a cable modem, comprising:
a TEK update time calculator calculating a TEK update time by using a time offset calculated through system synchronization between the cable modem termination system and the cable modem, an expiration time of a previously generated TEK, and time information that a key response message including the TEK is transmitted to the cable modem from the cable modem termination system;
a TEK updating unit updating the TEK by applying the TEK update time calculated by the TEK update time calculator and the previously generated TEK to a hash function; and
a TEK storage unit storing a TEK updated by the TEK update unit and the previously generated TEK.

8. The TEK updating system of claim 7, further comprising, if the TEK updating system is included in the cable modem termination system, a TEK generator generating a TEK to be provided to the cable modem based on a key request message that the cable modem termination system has received from the cable modem.

9. The TEK updating system of claim 8, further comprising, if the TEK updating system is included in the cable modem, a TEK requesting/receiving unit generating and transmitting a key request message for requesting a TEK from the cable modem termination system and receiving a TEK generated in the cable modem termination system.
